(19) United States
(12) Patent Application Publication
(10) Pub. No.: US 2005/0265409 A1
(43) Pub. Date: Dec. 1, 2005

(54) Laser emitting device of optical disc drive

(75) Inventors: Chih-Chiang Tsao, Hsinchu (TW); Cheng-Yao Liao, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/132,874

(22) Filed: May 19, 2005

(30) Foreign Application Priority Data
May 27, 2004 (TW) 093115118

(51) Int. Cl. H01S 3/04; G06K 7/10

(52) U.S. Cl. 372/34

(57) ABSTRACT

A laser emitting device of an optical disc drive includes a housing having a laser-transmissive portion; a laser-emitting element disposed in the housing for emitting a laser light through the laser-transmissive portion; and a semiconductor substrate integrating therewith a laser sensor and a thermal sensor and disposed in the housing at a position that an intensity of the laser light is detectable by the laser sensor and a temperature inside the housing is detectable by the thermal sensor. By integration, the production of the optical pickup head can be simplified.

### FIELD OF THE INVENTION

The present invention relates to a laser emitting device and more particularly to a laser emitting device of an optical disc drive.

### BACKGROUND OF THE INVENTION

Referring to FIG. 1(a), an optical pickup head 1 of an optical recording apparatus is shown. A laser beam emitted from a semiconductor laser module 11 is focused on a disc 2 via lens 14 and 15, and the light reflected by the disc 2 is transmitted to a photo detector 12 to realize information from the disc 2. In general, data are written into the disc 2 by modifying the recording material of the disc 2 with laser beam to leave distinctive marks on the disc 2. For writing data successfully, power of the laser beam emitted from the semiconductor laser module 11 is generally confined within a critical range. The laser power beyond the operable range would result in inferior data read-back performance or even read-back failure.

Further, depending on the types of discs to be recorded, the laser power applied thereto should be adjusted. For example, the optimum laser power may vary with the recording material of a disc. Recording data into a CD-R disc and recording data into a CD-RW disc also have different optimum laser power levels. Even the tolerable variation of laser power for recording a regular compact disc (CD) is different from that for recording a digital versatile disc (DVD) due to the difference in data intensity. Generally, the power of the laser beam emitted from the semiconductor laser module 11 varies with the electric power inputted thereinto. That is, as the input electric power is increased, the laser power provided for recording data increases, and as the input electric power is decreased, the laser power provided for recording data decreases. For adjusting laser power to fit different types of discs, a so-called optimum power control or optimum power calibration (OPC) means was developed for recording power test.

The test procedure executed with the OPC means is performed at a specific test area on the disc with different laser power levels of the semiconductor laser module 11 before a real recording operation of data. By measuring and comparing the resulting light reflected by the disc and detected by the photo detector 12 corresponding to different power levels with reference information, the electric power input capable of providing the semiconductor laser module 11 with an optimum writing laser power is determined. The process for controlling laser power of the optical pickup head of FIG. 1(a) is illustrated with reference to FIG. 1(b). If a write command is to be executed (S11), a trial-writing OPC procedure is first performed (S12). Then, the real writing procedure is performed with the optimum writing laser power determined in the trial-writing OPC procedure (S13).

In addition to input electric power, working temperature may also influence the laser power of the semiconductor laser module 11. In other words, even if a constant electric power is inputted, the laser power emitted by the semiconductor module 1 is still subject to change with temperature. Generally, the laser power would be decreased when the working temperature is too high or too low beyond the optimum range. Therefore, if the temperature changes significantly after the optimum power laser has been determined according to the optimum power calibration (OPC) test procedure, which is practically common due to environmental condition change or heat resulting from electric-to-photic energy transformation, the previously determined optimum laser power for writing the disc might become improper under the current temperature. If the laser power is not adjusted in response to the temperature variation, writing failure may occur in the subsequently writing operation. For minimizing the influence of the working temperature change on the laser power, a thermal sensor 13 is disposed in the optical pickup head 1 to monitor the temperature change, as can be seen in FIG. 2(a).

The process for controlling laser power of the optical pickup head of FIG. 2(a) is illustrated with reference to FIG. 2(b). If a write command is to be executed (S21), a trial-writing procedure, e.g. an optimum power calibration (OPC) procedure, is first performed (S22). Then, the real writing procedure is performed with the optimum writing laser power determined in the trial-writing OPC procedure (S23). During the writing procedure, the thermal sensor 13 continuously monitors the temperature change within the optical pickup head 1. Once the temperature change measured by the thermal sensor 13 is larger than the threshold value, for example 3° C., during the process of writing the disc (S24), the adjustment of the laser power is done (S25). That is, the electric power inputted into the optical pickup head 1 is adjusted according to the temperature detected by the thermal sensor 13. In this way, the laser power can be maintained at an almost constant level during the writing procedure.

Conventionally, the thermal sensor 13 is implemented with a thermistor or heat sensor and mounted in the optical pickup head 1. Since mounting of the thermal sensor into the circuitry of the optical pickup head would complicate assembling of the optical pickup head, it is cost-inefficient.

### SUMMARY OF THE INVENTION

The present invention provides a laser emitting device which integrates therewith a thermal sensor so as to simplify assembling of the optical pickup head of the optical disc drive.

The present invention provides a laser emitting device of an optical disc drive, comprising a housing having a laser-transmissive portion; a laser-emitting element disposed in the housing for emitting a laser light through the laser-transmissive portion; and a semiconductor substrate integrating therewith a laser sensor and a thermal sensor and disposed in the housing at a position that an intensity of the laser light is detectable by the laser sensor and a temperature inside the housing is detectable by the thermal sensor.

For example, the semiconductor substrate is a silicon substrate and the laser sensor and thermal sensor are formed on the silicon substrate by a CMOS manufacturing process. In an embodiment, the laser-emitting element is separate from the semiconductor substrate. Alternatively, the laser-emitting element is disposed on the semiconductor substrate.

For example, the laser-emitting element is a laser diode, the laser sensor is implemented with a photo diode, and the thermal sensor is implemented with a heat sensing circuit.

The present invention also provides a laser emitting device of an optical disc drive, comprising a housing having a laser-transmissive portion; and a semiconductor substrate integrating therewith a laser emitting element for emitting a laser light through the laser-transmissive portion and a thermal sensor for detecting a temperature inside the housing.

Preferably, the semiconductor substrate further integrates therewith a laser sensor for detecting an intensity of the laser light. In an embodiment, the laser-emitting element is formed above a silicon substrate with the laser sensor and thermal sensor.

The present invention also provides a method for producing a laser emitting device, comprising steps of forming a circuit including a photo diode portion and a heat sensing portion on a first semiconductor substrate as a laser sensor and a thermal sensor; forming a laser diode on a second semiconductor substrate as a laser emitting element; combining the resulting semiconductor substrates together with the laser diode coupled to the circuit; and removing the second semiconductor substrate to expose the laser diode.

Preferably, the method further comprises a step of forming a laser-transmissive protection layer over the circuit and the laser diode.

For example, the first semiconductor substrate is a silicon substrate, and the second semiconductor substrate is a gallium arsenate (GaAs) substrate.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a schematic diagram illustrating a typical optical pickup head of a disc recording apparatus;

FIG. 1(b) is a flowchart illustrating the process for controlling laser power inputted into the optical pickup head of FIG. 1(a);

FIG. 2(a) is a schematic diagram illustrating another typical optical pickup head of a disc recording apparatus;

FIG. 2(b) is a flowchart illustrating the process for controlling laser power inputted into the optical pickup head of FIG. 2(a);

FIG. 3 is a schematic diagram illustrating a semiconductor laser module for use in an optical pickup head of an optical drive according to an embodiment of the present invention;

FIG. 4 is a schematic diagram illustrating a semiconductor laser module for use in an optical pickup head of an optical drive according to a another embodiment of the present invention;

FIGS. 5(a)˜5(e) are schematic cross-sectional views illustrating the production of the semiconductor laser module of FIG. 4.

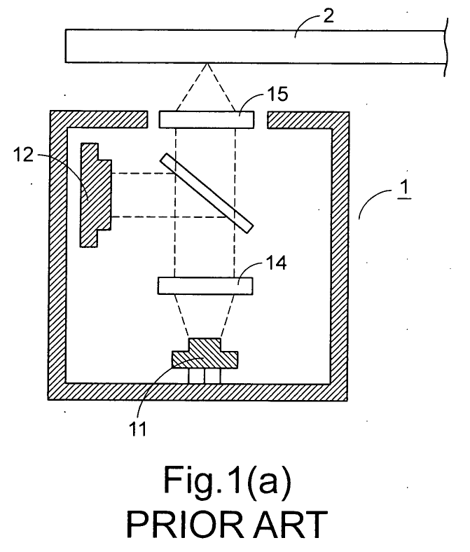

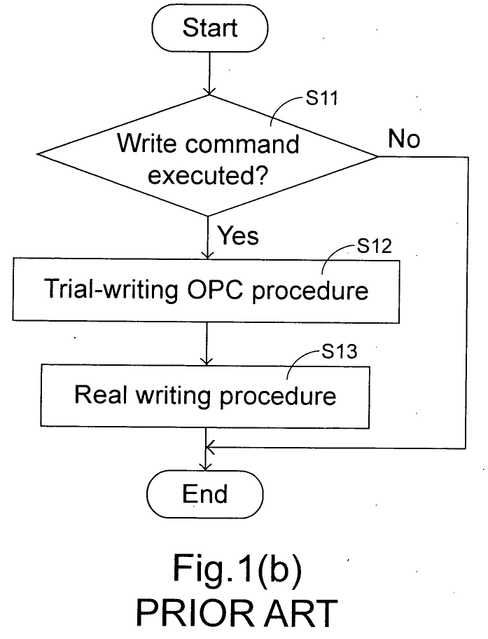

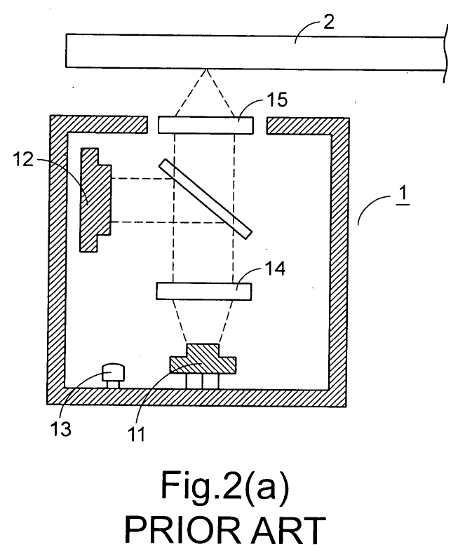

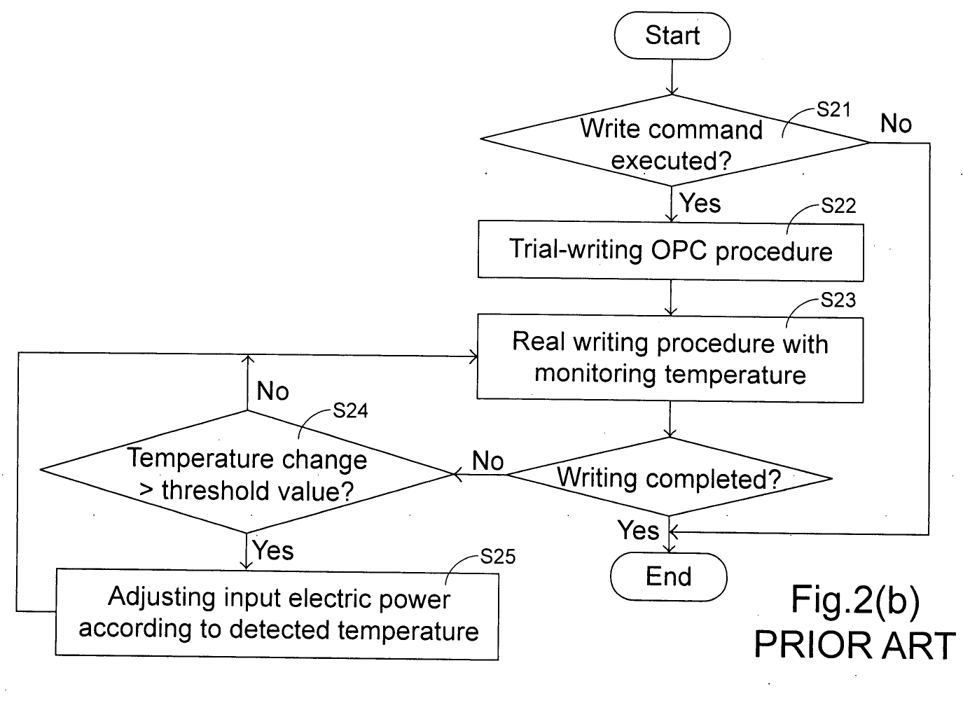

### DETAILED DESCRIPTION OF THE PREFERRED EMBODIMENT

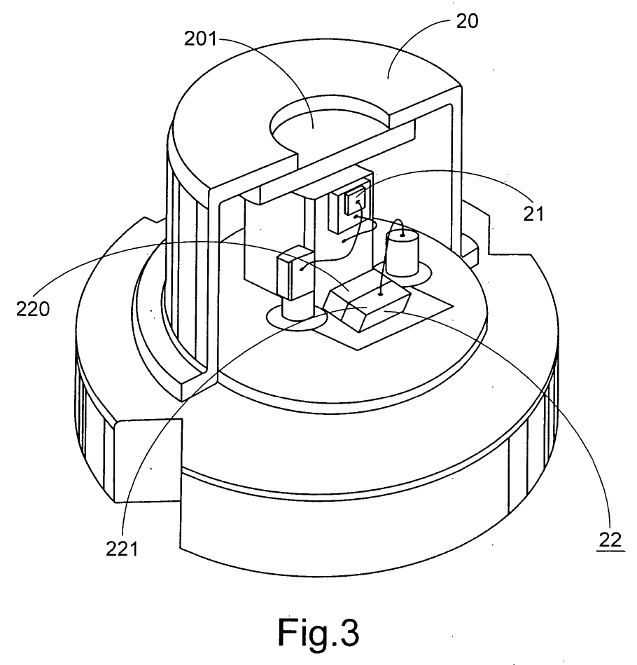

Hereinafter, a semiconductor laser module is exemplified and illustrated as the laser emitting device according to an embodiment of the present invention. In order to have the elements inside the semiconductor laser module visible, the housing 20 of the semiconductor laser module is partially cut off in FIG. 3. As shown, there is a laser-transmissive window 201 arranged in the housing 20. The semiconductor laser module includes a laser-emitting element 21 for emitting laser light to an optical disc (not shown) through the laser-transmissive window 201. The laser-emitting element 21, for example, is a laser diode. The semiconductor laser module further includes a semiconductor substrate 22 forming thereon a laser sensor 220 and a thermal sensor 221. The laser sensor 220, e.g. a photo diode, detects and converts the intensity of the laser light emitted by the laser-emitting element 21 into an electric signal, and the thermal sensor 221, e.g. a heat sensing circuit, detects the temperature inside the housing 20. The information realized by the laser senor 220 and thermal sensor 221 can be subsequently processed by the circuit of the optical pickup head (not shown) for OPC adjustment.

In this embodiment, the laser senor 220 and thermal sensor 221 are integrally formed on the same semiconductor substrate 22, e.g. silicon substrate, so that the production of the optical pickup head is simplified. For example, the laser senor 220 and thermal sensor 221 can be formed on the silicon substrate by a CMOS manufacturing process.

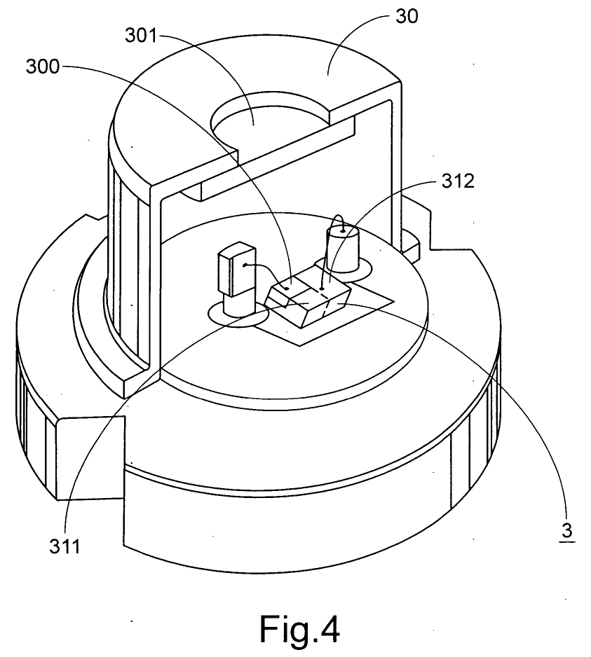

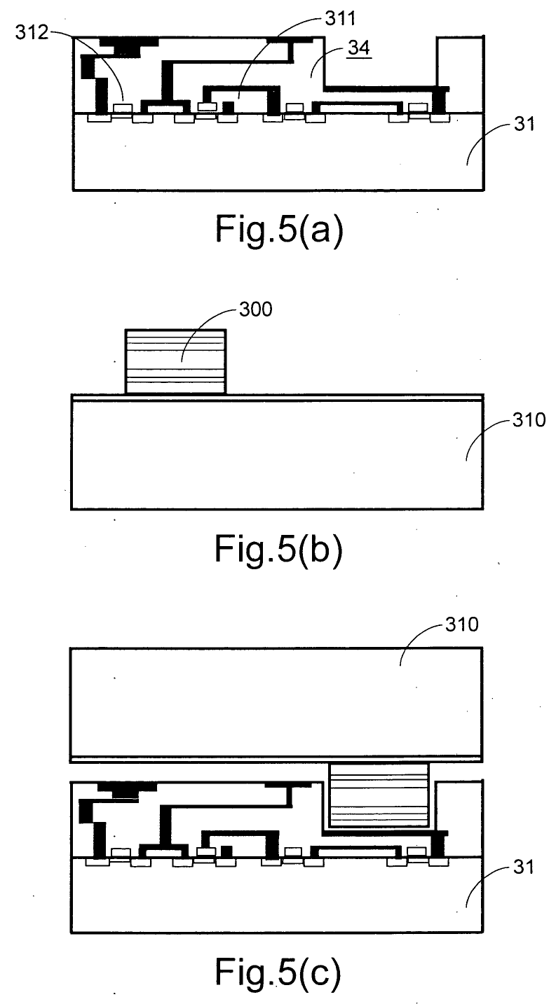

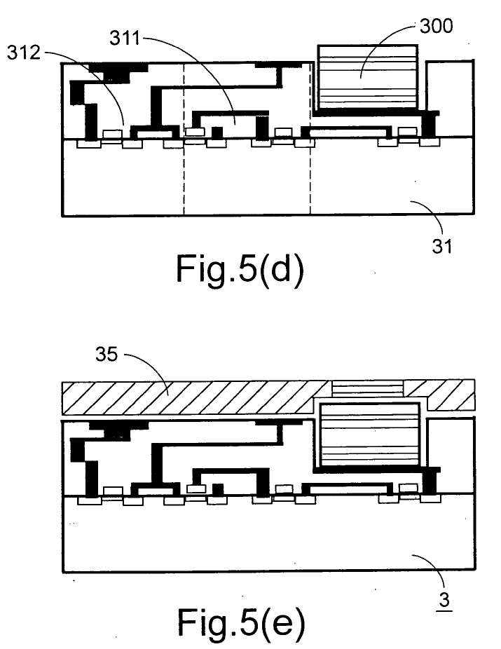

In another embodiment, laser emitting element 300, laser senor 311 and thermal sensor 312 are combined together as schematically shown in FIG. 4. Likewise, the housing 30 of the semiconductor laser module of FIG. 4 is partially cut off in order to have the elements inside the semiconductor laser module visible. Also, the housing 30 has a laser-transmissive window 301 for penetrating therethrough the laser light to be projected on an optical disc. For integrating the laser emitting element 300, laser senor 311 and thermal sensor 312, a producing method will be illustrated with reference to FIGS. 5(a)˜5(e).

First, a CMOS manufacturing process is performed to form a circuit 34 on a silicon substrate 31, as shown in FIG. 5(a). The circuit 34 includes a photo diode portion and a heat sensing portion functioning as the laser sensor 311 and thermal sensor 312. On the other hand, a laser diode is formed on a gallium arsenate (GaAs) substrate 310 to serve as the light emitting element 300, as shown in FIG. 5(b). Then, the resulting GaAs substrate is attached to the resulting silicon substrate with the laser diode 300 coupled to the circuit 34, as shown in FIG. 5(c). Afterwards, the GaAs substrate 310 is removed to expose the laser diode 300, as shown in FIG. 5(d). In order to protect the resulting structure, it is preferred a laser-transmissive layer 35 is applied over the circuit 34 and laser diode 300, as shown in FIG. 5(e), to obtain the assembly 3 of FIG. 4.

In this embodiment, the laser-emitting element 300, laser senor 311 and thermal sensor 312 are integrated as an assembly 3 so that the production of the optical pickup head is simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A laser emitting device of an optical disc drive, comprising:
a housing having a laser-transmissive portion;
a laser-emitting element disposed in said housing for emitting a laser light through said laser-transmissive portion; and
a semiconductor substrate integrating therewith a laser sensor and a thermal sensor and disposed in said housing at a position that an intensity of said laser light is detectable by said laser sensor and a temperature inside said housing is detectable by said thermal sensor.

2. The laser emitting device according to claim 1 wherein said semiconductor substrate is a silicon substrate and said laser sensor and thermal sensor are formed on said silicon substrate by a CMOS manufacturing process.

3. The laser emitting device according to claim 1 wherein said laser-emitting element is separate from said semiconductor substrate.

4. The laser emitting device according to claim 1 wherein said laser-emitting element is disposed on said semiconductor substrate.

5. The laser emitting device according to claim 1 wherein said laser-emitting element is a laser diode.

6. The laser emitting device according to claim 1 wherein said laser sensor is implemented with a photo diode.

7. The laser emitting device according to claim 1 wherein said thermal sensor is implemented with a heat sensing circuit.

8. A laser emitting device of an optical disc drive, comprising:
a housing having a laser-transmissive portion; and
a semiconductor substrate integrating therewith a laser emitting element for emitting a laser light through said laser-transmissive portion and a thermal sensor for detecting a temperature inside said housing.

9. The laser emitting device according to claim 8 wherein said semiconductor substrate further integrates therewith a laser sensor for detecting an intensity of said laser light.

10. The laser emitting device according to claim 9 wherein said semiconductor substrate includes a silicon substrate on which said laser sensor and thermal sensor are formed by a CMOS manufacturing process, and said laser-emitting element is formed above the resulting silicon substrate with said laser sensor and thermal sensor.

11. The laser emitting device according to claim 8 wherein said laser-emitting element is a laser diode.

12. The laser emitting device according to claim 9 wherein said laser sensor is implemented with a photo diode.

13. The laser emitting device according to claim 8 wherein said thermal sensor is implemented with a heat sensing circuit.

14. A method for producing a laser emitting device, comprising steps of:
forming a circuit including a photo diode portion and a heat sensing portion on a first semiconductor substrate as a laser sensor and a thermal sensor;
forming a laser diode on a second semiconductor substrate as a laser emitting element;
combining the resulting semiconductor substrates together with said laser diode coupled to said circuit; and
removing said second semiconductor substrate to expose said laser diode.

15. The method according to claim 14 further comprising a step of forming a laser-transmissive protection layer over said circuit and said laser diode.

16. The method according to claim 14 wherein said first semiconductor substrate is a silicon substrate.

17. The method according to claim 14 wherein said second semiconductor substrate is a gallium arsenate (GaAs) substrate.

18. The method according to claim 14 wherein said circuit is formed on said first semiconductor substrate by a CMOS manufacturing process.
